(19) United States
(12) Patent Application Publication
(10) Pub. No.: US 2023/0126564 A1
(43) Pub. Date: Apr. 27, 2023

(54) COLPOTOMY MODEL

(71) Applicant: Applied Medical Resources Corporation, Rancho Santa Margarita, CA (US)

(72) Inventors: Jacqueline Foss, Foothill Ranch, CA (US); Gregory K. Hofstetter, Rancho Santa Margarita, CA (US); Oscar Raygan, Rancho Santa Margarita, CA (US)

(21) Appl. No.: 17/971,484

(22) Filed: Oct. 21, 2022

Related U.S. Application Data
(60) Provisional application No. 63/271,022, filed on Oct. 22, 2021.
(60) Provisional application No. 63/290,586, filed on Dec. 16, 2021.

(51) Int. Cl. G09B 23/32; G09B 23/34; G09B 23/30

(52) U.S. Cl. CPC G09B 23/32; G09B 23/34; G09B 23/303

(57) ABSTRACT

A colpotomy model is provided for assisting in the training and practice of users performing a colpotomy procedure. The colpotomy model has a simulated vaginal opening which covers a proximal end of a simulated pelvic frame and a simulated vaginal canal which defines an internal space that encompasses a simulated cervix. The simulated cervix is suspended via at least one cord to provide a realistic response to user interaction with the simulated cervix. The user is directed to manipulate the simulated cervix and make one or more incisions where the simulated vaginal canal becomes reflected near the simulated cervix from the manipulations. The user is then directed to continue through the colpotomy model to access a simulated peritoneal cavity or other portions of the colpotomy model in accordance with a simulated procedure being performed.

### CROSS-REFERENCE TO RELATED APPLICATIONS

This application claims priority to and benefit of both U.S. Provisional Patent Application Ser. No. 63/271,022 entitled “Colpotomy Model” filed on Oct. 22, 2021 and U.S. Provisional Patent Application Ser. No. 63/290,586 entitled “Colpotomy Model” filed on Dec. 16, 2021 which are incorporated herein by reference in their entirety.

### FIELD OF THE INVENTION

The present application generally relates to surgical training systems, and in particular, to simulated tissue structures and models for teaching and practicing various surgical techniques and procedures related but not limited to laparoscopic, endoscopic, and minimally invasive surgery. More specifically, the surgical training system is provided for teaching and practicing a colpotomy procedure with a transvaginal approach.

### BACKGROUND OF INVENTION

Medical students as well as experienced professionals (e.g., surgeons) learning new surgical techniques undergo extensive training before being qualified to perform surgery on human patients. Some of that training involves allowing users to practice proper techniques employed to perform surgery which may involve one or more of cutting, penetrating, clamping, grasping, stapling, cauterizing, and suturing various tissue types. To that end, some surgical training systems present useful teaching tools that allow users to practice on and experience a variety of different anatomies and scenarios that correspond to different surgical procedures users would actually perform. This allows users to practice the many different surgical techniques in various surgical conditions as well as for different surgical procedures. Furthermore, surgical conditions can also be influenced by patient-specific factors such as the size and condition of the patient, the anatomical landscape associated with the surgical procedure as well as nearby areas, and the types of tissue being operated on that may or may not be immediately accessible by the user.

Some teaching aids, trainers, simulators, and model organs are available that facilitate in the training and practice of one or more aspects of different surgical procedures. However, there is a need for models or simulated tissue elements that are specifically designed to aid in training and practicing specific surgical procedures.

For example, there is a need for surgical training systems that are designed to provide a more accurate and responsive simulation particularly for a simulated colpotomy. Furthermore, features associated with the surgical training systems would also be desired that would allow for users to practice such surgical procedures with or without electrosurgical energy or a combination thereof.

### SUMMARY OF THE INVENTION

In accordance with various embodiments a surgical model is described herein. The surgical model includes a simulated pelvic frame having a proximal end and a distal end. The simulated pelvic frame has an opening at the proximal end and has an internal cavity that can house one or more simulated tissue structures. The one or more tissue structures include a simulated vaginal canal and a simulated cervix. The simulated vaginal canal defines an internal space which has a first section near a proximal end that has ridges and a second section near a distal end that is smooth. The simulated cervix is connected to the distal end of the simulated vaginal canal such that a proximal end of the simulated cervix extends into the simulated vaginal canal and a distal end of the simulated cervix extends past the distal end of the simulated vaginal canal. The simulated cervix is suspended within the simulated pelvic frame via at least one cord. The cord is connected to the simulated pelvic frame and allows the simulated cervix to move back and forth in response to user manipulation which causes the simulated vaginal canal near the simulated cervix to move as well. Based on the movements of the simulated vaginal canal, a user can learn to identify where an incision would need to be performed.

In accordance with various embodiments, the surgical model also includes a simulated vesicocervical space that is described herein. The simulated vesicocervical space is made of two or more layers which has portions which are molded together and other portions which are attached together with an interface material. Based on the type of attachment between the two layers, different types of dissection would be used. In this manner, a user can be taught how to identify where the plane of dissection corresponding to where the user is supposed to dissect through this space corresponding to where the simulated vesicocervical space allows for blunt dissection as opposed to sharp dissection.

In accordance with various embodiments, the surgical model also includes a simulated bladder. The simulated bladder is made to expand using a filling tube and attached pump that is used to introduce liquid or air into the balloon causing it to expand. The simulated bladder also has portions that have been reinforced with support structures that helps control the direction in which the balloon will expand.

In accordance with various embodiments, the simulated cervix of the surgical model can include an additional support structure (i.e. connector) that is attached to the distal end of the simulated cervix. The simulated cervix and/or the support structure can be made of yarn that is wrapped/weaved around a three-dimensional mandrel and cast with a layer of electro-conductive material. The simulated cervix and/or the support structure can be made hollow and later filled with support materials.

### BRIEF DESCRIPTION OF THE DRAWINGS

The present inventions may be understood by reference to the following description, taken in connection with the accompanying drawings in which the reference numerals designate like parts throughout the figures thereof.

FIG. 1A and FIG. 1B illustrate an example colpotomy model.

FIG. 2A-2H illustrate example embodiments of internal components of the colpotomy model.

FIG. 3 illustrates the example components of the colpotomy model not assembled in a simulated pelvic frame.

FIG. 4A-FIG. 4D illustrate different views of a colpotomy model.

FIG. 5 illustrates internal components of the colpotomy model arranged within the simulated pelvic frame.

FIG. 6A and FIG. 6B illustrate example arrangement of the one or more cords.

FIG. 7A-7F illustrate steps of the colpotomy procedure performed on the colpotomy model.

FIG. 8 is a top perspective view of a surgical training device according to the present invention.

FIG. 9A and FIG. 9B are embodiments of the surgical training device housing the colpotomy model.

### DETAILED DESCRIPTION OF THE INVENTION

In accordance with various embodiments of the present invention, a colpotomy model is provided. The colpotomy model comprises a way for users (e.g., medical students, medical professionals) to teach and/or practice how to perform a colpotomy procedure. The colpotomy procedure involves the user to form incisions in the back wall of the vagina near the cervix. For example, a vaginal hysterectomy procedure is completed via a vaginal approach through a circumferential incision around the cervix and involves the removal of the cervix and the uterine fundus.

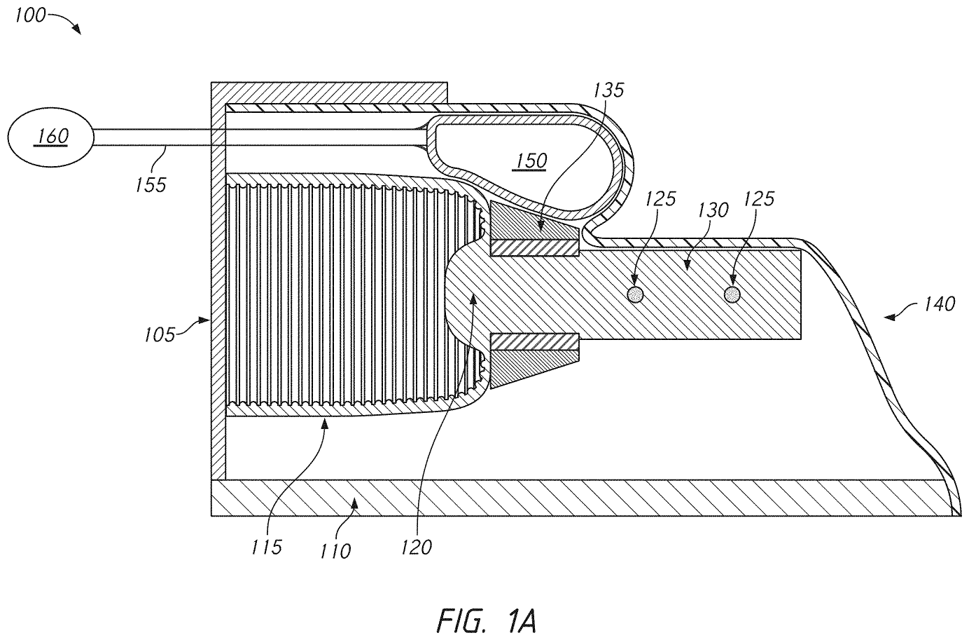

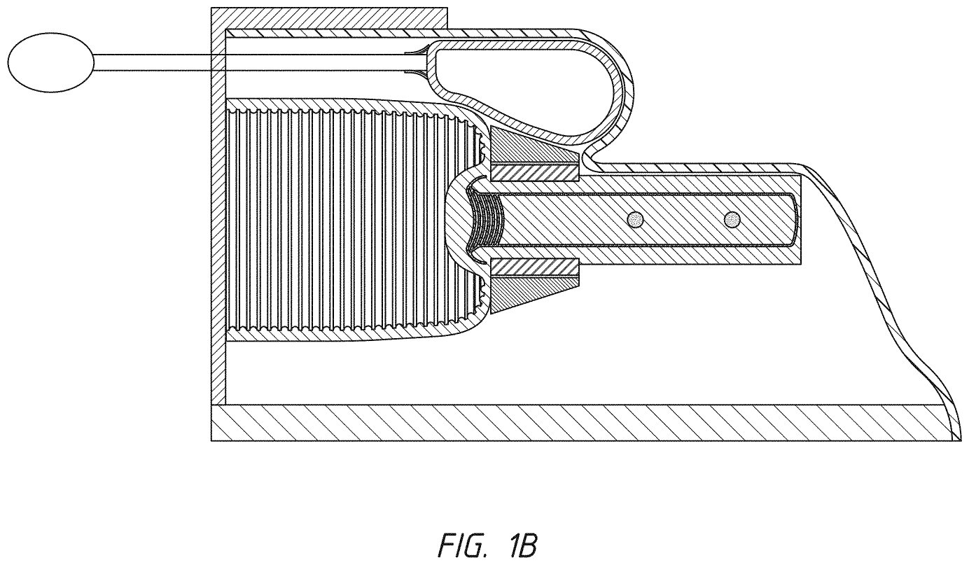

Referring to FIGS. 1A-B, the figures illustrate, in accordance with various embodiments, an example colpotomy model 100. Although the figure illustrates a number of elements making up the example colpotomy model 100, it should be noted that additional elements (i.e. additional tissue structures) may be included. In addition, to simply the overall model, features illustrated in the example colpotomy model 100 may also be removed/removable.

At a proximal most end of the colpotomy model (i.e., the left most part of the figure) is a simulated vaginal opening 105 which covers a proximal end of a simulated pelvic frame 110 (of which a base is shown in this view). In various embodiments, the simulated vaginal opening 105 comprises simulated tissue that is attached to a top portion (e.g., a cover) of the simulated pelvic frame 110 and extends down the entire height of the simulated pelvic frame 110 to the base of the simulated pelvic frame 110. In various embodiments, a grounding pad may be associated with any part of the simulated vaginal opening so long as the opening to the vaginal canal is not obstructed. For example, the grounding pad may be placed on the top portion of the simulated pelvic frame.

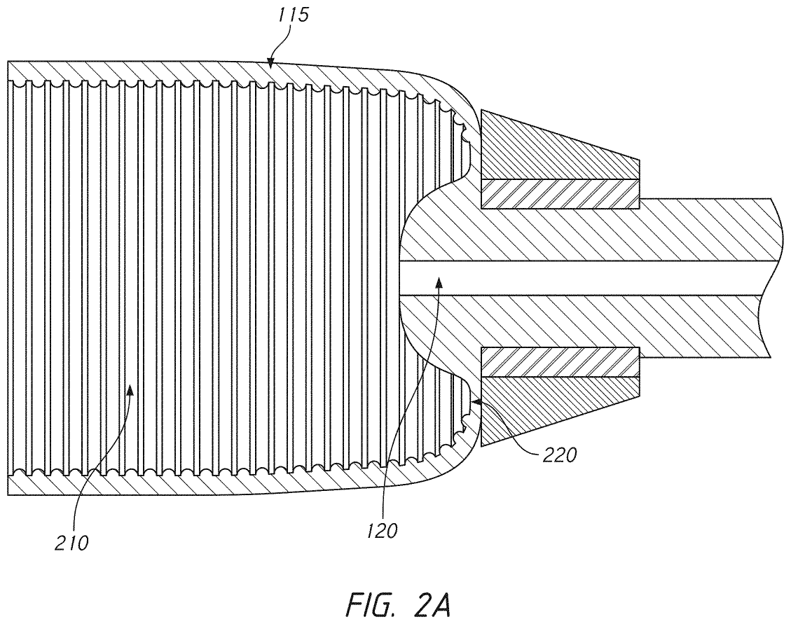

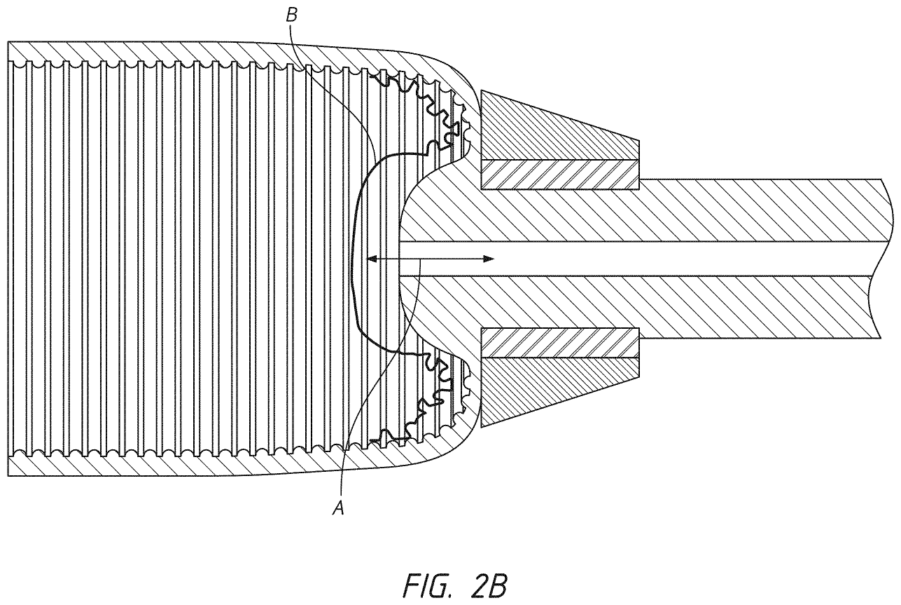

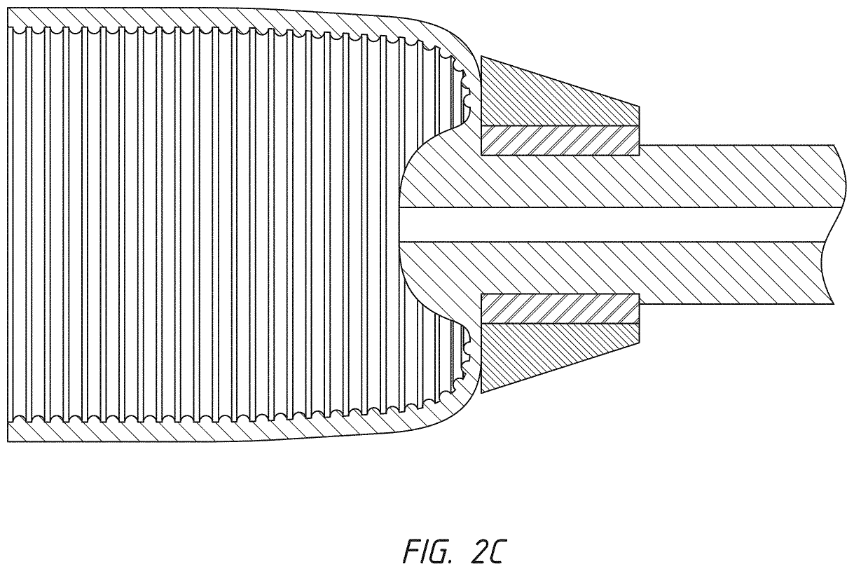

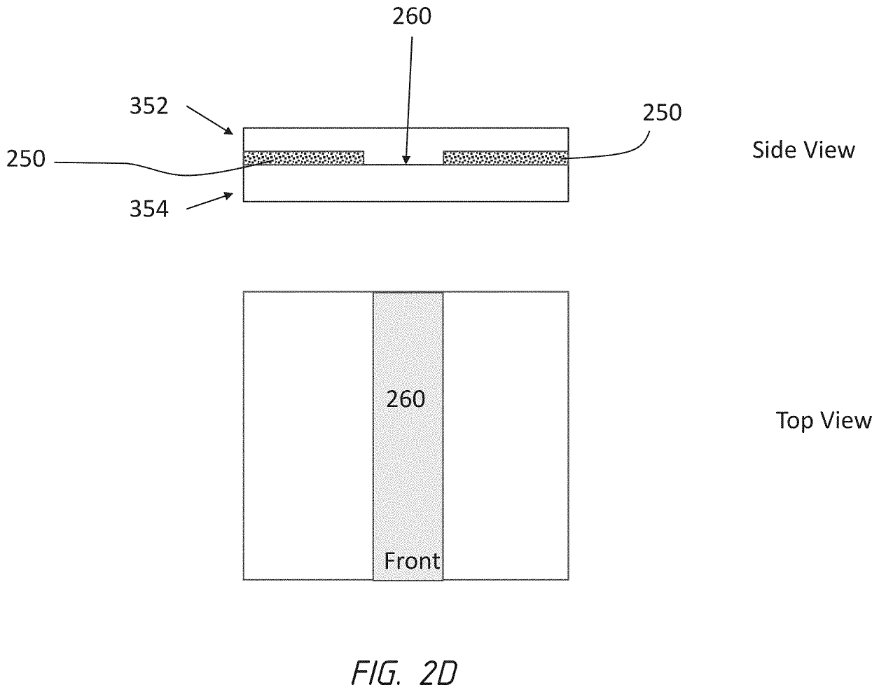

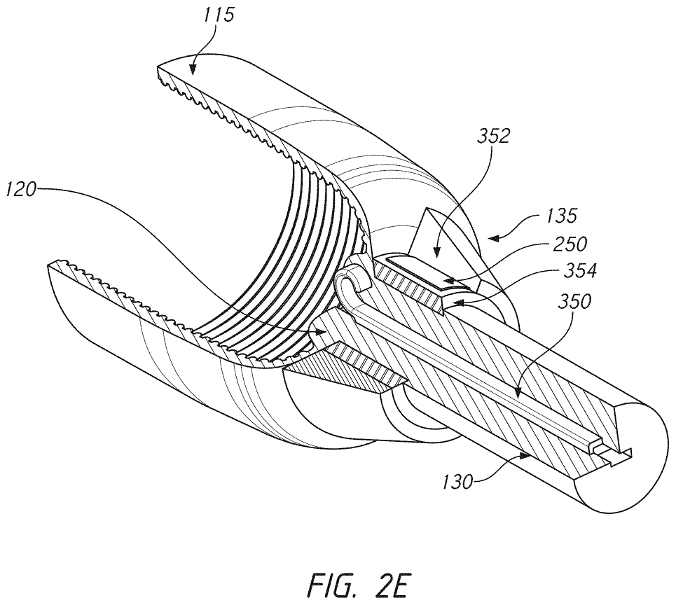

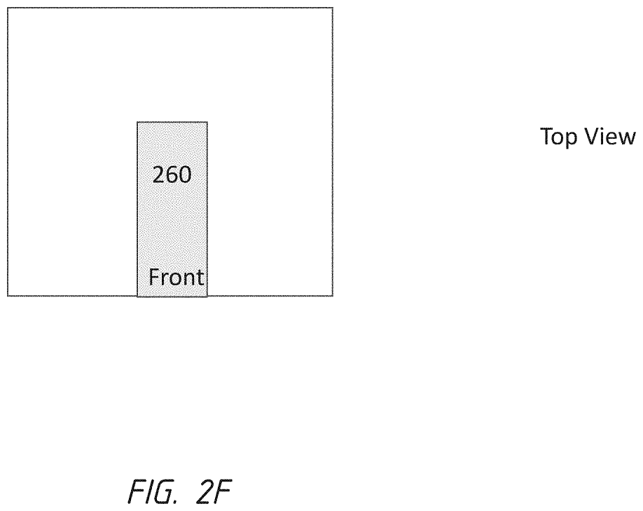

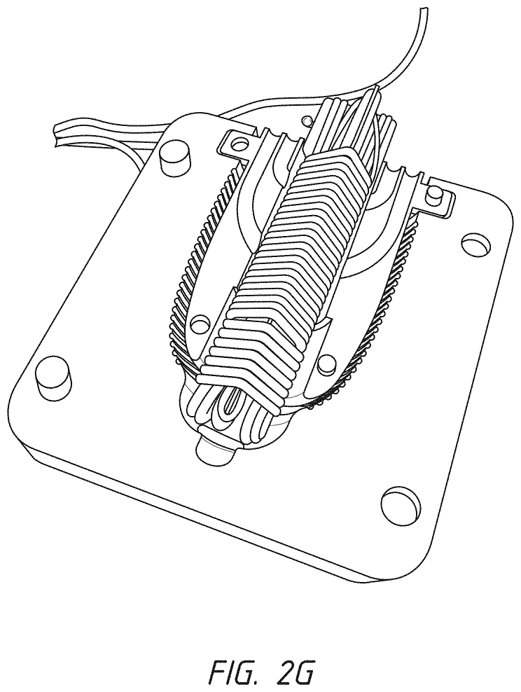

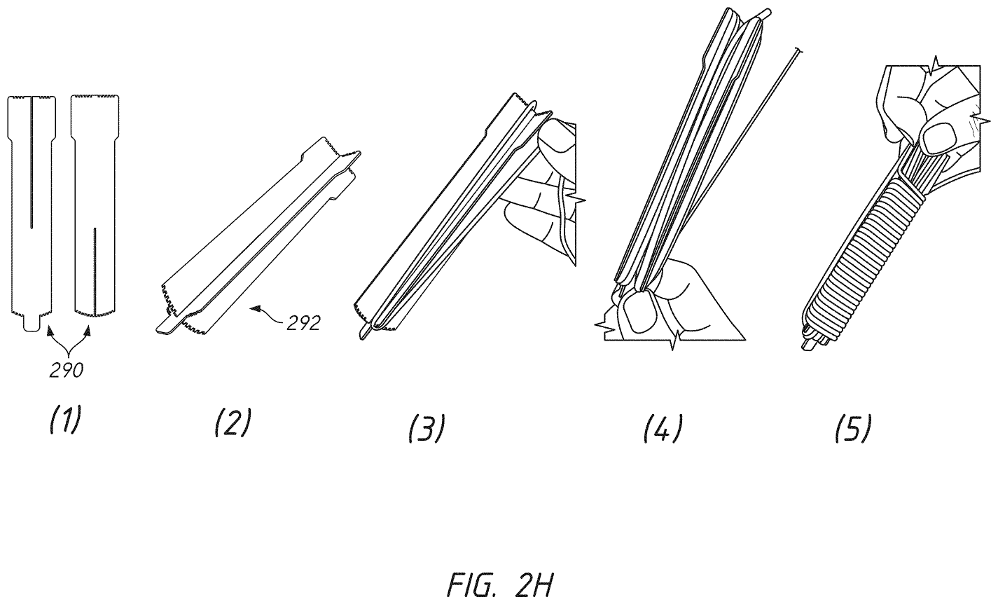

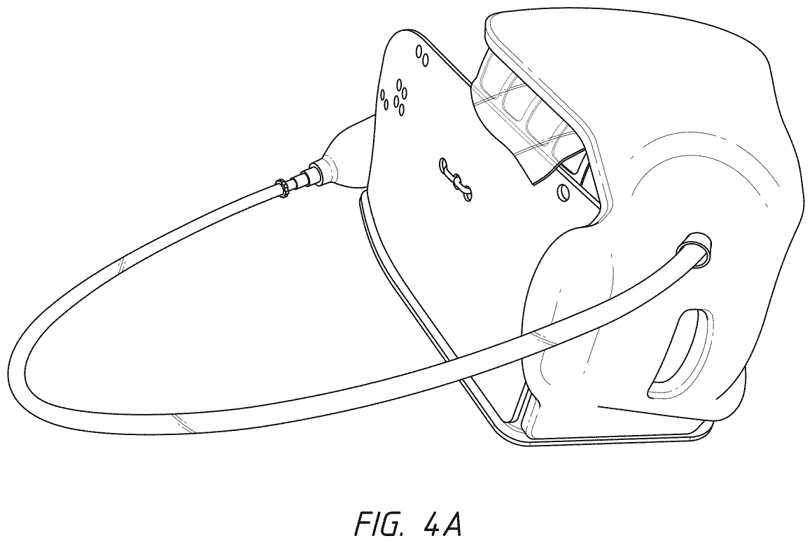

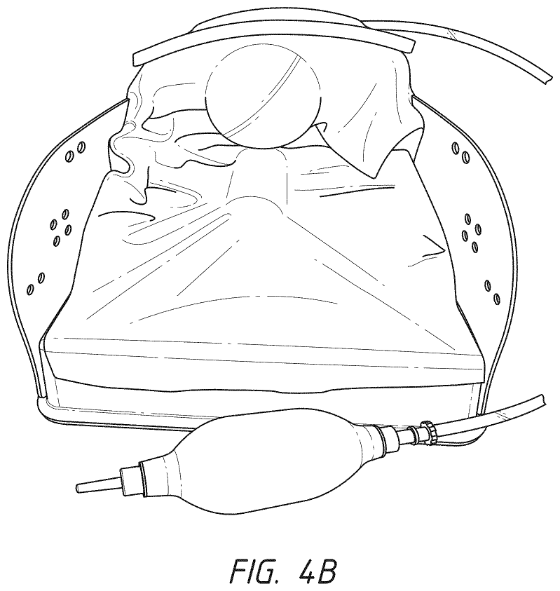

The opening of the simulated vaginal opening 105 (as seen, for example, in FIG. 4A) leads to a simulated vaginal canal 115. The simulated vaginal canal 115 defines an internal space which encompasses a portion of a simulated cervix 120. As shown for example in FIGS. 2A-C, in accordance with various embodiments, the simulated vaginal canal 115 has two distinct sections. A first section 210 of the simulated vaginal canal has a plurality of ridges to provide a simulated rugae. The first section starts at the proximal end of the simulated vaginal canal 115 and terminates where the second section 220 begins. The second section 220 is smooth and is located near a circumferential area of the simulated vaginal canal 115 where the simulated vaginal canal 115 is connected to the simulated cervix 120.

The distinctions or delineation between the two different sections or areas 210, 220 provide the user a visual landmark or indicator where to make an incision in the simulated vaginal canal 115. Another landmark or indicator that is used and provided by the colpotomy model to identify where incisions should be made corresponds to where the simulated vaginal canal reflects onto the simulated cervix through a motion called “rolling.” “Rolling” (as associated with the simulated vaginal canal) refers to the manipulation of the simulated cervix (e.g., back and forth). Generally, the point where an incision will be performed is located in the second section 220 where the simulated vaginal canal reflects onto the simulated cervix.

With reference to FIG. 2B, the figure illustrates an example scenario where the simulated cervix is moved from a first position A to a second position B (e.g., white line). The movement of the simulated cervix (e.g., “rolling”) causes a portion of the simulated vaginal canal to move with the simulated cervix. In particular, a portion of the simulated vaginal canal will become more concave/fold onto itself around the simulated cervix as the simulated cervix moves from the first position A to the second position B corresponding to an area of the simulated vaginal canal where an incision for the colpotomy procedure is desired.

By creating an incision at the “rolling” point of the simulated vaginal canal, the user is able to gain access to the simulated vesicocervical space. In particular, the user is able to avoid inadvertently dissecting, incising, and/or cutting into the simulated cervix or the simulated bladder. FIG. 2C illustrates an example point in the second section of the simulated vaginal canal where an incision would be placed.

With reference back to FIG. 1A, the simulated cervix 120 is designed to move in response to user manipulation (e.g., pulling in and out) which in turn creates the “rolling” in portions of the simulated vaginal canal 115. The movement is facilitated via at least one cord 125 which is attached to a connector or support 130 that is distally connected to the simulated cervix 120 past the simulated vaginal canal 115. The connector 130, which is illustrated as extending from the simulated cervix 120, in various embodiments, can correspond to the location of a uterus. In various embodiments, for the purposes of simulating the colpotomy procedure, a simulated uterus could be provided. However, in various embodiments, including the illustrated embodiment, a simulated uterus is not provided, saving resources, reducing waste and easing assembly and manufacturability of the model. The connector 130 facilitates in the suspension and movement of the simulated cervix 120 and the simulated vaginal canal 115 via the cords 125.

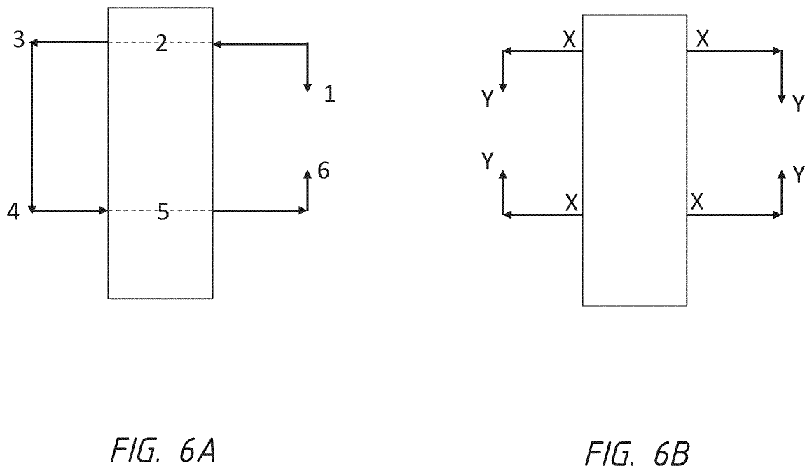

In various embodiments, a single cord 125 can be used to suspend the simulated cervix 120 via the connection with the connector 130 distally connected to the simulated cervix 120. For example, a cord 125 may be threaded and looped through the connector 130 as shown, for example, in FIG. 6A. In other embodiments, two or more cords 125 can be used, for example, as in FIG. 6B. For example, two sets of cords 125 can be attached at opposite sides of the connector and used to connect the respective side of the connector with the simulated pelvic frame 110. In various embodiments, the cords 125 are threaded through apertures within the walls of the simulated pelvic frame 110 to connect the connector 130 to the simulated pelvic frame 110.

After dissecting through the simulated vaginal canal 115, the user gains access into a simulated vesicocervical space 135. An embodiment of the simulated vesicocervical space can be seen in FIG. 2D. In particular, a side view and a top view of the simulated vesicocervical space is provided depicting an exemplary partial cross-sectional cutaway portion of the simulated vesicocervical space. With reference first to the side view, in various embodiments, the simulated vesicocervical space is defined by at least two layers 352, 354. Between the two layers 352, 354 is an interface layer or material 250 (e.g., silicone grease) that is added at various portions that provides the at least two layers 352, 354 with partial adherence to each other. The interface material 250 (e.g., silicone grease) facilitates defining a plane of separation where the two layers are separable from each other via use of blunt dissection to separate. This plane of separation corresponds to the plane which users (e.g., surgeons) would follow during a colpotomy procedure to access the peritoneum further behind the simulated vesicocervical space. As such, in various embodiments, the interface material or layer is or acts as a resist, release, or separation material or layer that allows or facilitates the separation or intended separation of layers or structures of which the interface material or layer is disposed therebetween.

In areas outside of the plane of separation (i.e. where there is no silicone grease), the at least two layers 352, 354 of the simulated vesicocervical space 135 are fully adhered to each other (e.g., molded together). The portions where the two layers 352, 354 of the simulated vesicocervical space 135 are connected to each other correspond to at least one simulated vesicovaginal septa 260.

With reference to the top view (which imagines an upper portion of 352 removed), the filled in section corresponds to the location where the layers 352, 354 of the simulated vesicocervical space 135 are fully adhered to one another, forming the simulated vesicovaginal septa 260. The “front” of the top view corresponds to the portion of the simulated vesicocervical space 135 which is entered by the user after dissecting through the “rolling” portion of the simulated vaginal canal.

The portions where the layers 352, 354 are fully adhered correspond to the simulated vesicovaginal septa 260 and are harder to separate from one another compared to other sections or portions of the simulated vesicovaginal space 135 where the interface material 250 is located between the layers 352, 354. To separate the layers 352, 354 at one of the vesicovaginal septa 260, users would have to use sharp dissection (e.g., snip), as opposed, for example, to other portions where blunt dissection can be used.

In various embodiments, the simulated vesicocervical space 135 is attached, e.g., cast, as two separate layers onto the simulated vaginal canal 115, the connector 130 and/or portions of the simulated cervix 120; that is the lower portion of the simulated vesicocervical space 135 (corresponding to element 354) is cast onto the simulated vaginal canal 115, the connector 130, and/or portions of the simulated cervix 120 with the top portion of the simulated vesicocervical space 135 (corresponding to element 352) being cast afterwards. In other embodiments, the lower portion of the simulated vesicocervical space 135 is cast alongside/together with the simulated cervix. The top portion of the simulated vesicocervical space 135 is cast separate from and after the lower portion of the simulated vesicocervical space 135. This allows for the removal of a casting step (i.e. casting the lower portion of the simulated vesicocervical space 354 separate from the simulated cervix 120) thereby simplifying manufacturing and/or reducing costs.

In various embodiments, the simulated vesicocervical space 135 is colored different from the simulated cervix and the simulated vaginal canal 115. The difference in coloration provides a visual cue or indicator to allow users to visually confirm and identify where dissection should occur. In various other embodiments, the coloration for the simulated vaginal canal 115, simulated cervix, and/or the simulated vesicocervical space 135 can be similar thereby requiring the user to discern where dissection should occur based on the movement of the simulated cervix and where the rolling of the simulated vaginal canal 115 is located.

With reference back to FIG. 1A, the user is directed to dissect through the simulated vesicocervical space 135 towards the back or distal end of the colpotomy model 100. By following the plane of separation of the simulated vesicocervical space 135, the user avoids dissecting into other spaces (e.g., bladder, uterus) and instead approaches the simulated peritoneum layer 140. The simulated peritoneum layer 140 is attached at the distal end of the colpotomy model 100 and is used to separate the proximal interior of the simulated pelvic frame 110 from the distal opening of the simulated pelvic frame 110 (which may correspond to a simulated peritoneal cavity). The simulated peritoneum layer 140 is attached at various points (e.g., via adhesives) with the simulated pelvic frame 110, the simulated bladder 150, and/or the connector 130. In various embodiments, a conductive adhesive, e.g., a chitosan glue, connects the simulated bladder 150 and/or the connector 130 to the simulated peritoneum layer 140. In various embodiments, a non-conductive adhesive, such as Loctite glue, connects the simulated peritoneum layer 140 to the simulated pelvic frame 110.

After dissecting through the simulated vesicocervical space 135, the user proceeds to identify the location of the simulated peritoneal reflection 145 of the simulated peritoneum layer 140. Generally, the simulated peritoneal reflection 145 corresponds to a point in the simulated peritoneum layer 140 where the simulated peritoneum layer 140 appears more convex (e.g., folds on itself in the opposite direction towards the distal end of the colpotomy model 100 similar to the “rolling” of the simulated vaginal canal 115). At the simulated peritoneal reflection 145, the user proceeds to dissect at that location of the simulated peritoneum layer 140 to, in various embodiments, access a simulated peritoneal cavity behind the simulated peritoneum layer 140. Dissection at the simulated peritoneal reflection 145 ensures that the user is accessing the simulated peritoneal cavity and not further dissecting into the simulated cervix/connector, the simulated bladder, and/or areas surrounding the simulated bladder.

The simulated bladder 150 as illustrated is located above the simulated vesicocervical space 135, the simulated vaginal canal 115, and the connector 130. In various embodiments, the simulated bladder 150 is connected to a filling tube 155 (via heat shrink seal or a connector/nut) and a pump 160. The simulated bladder 150 may be cast to form a balloon-shaped object used to expand in a manner similar to an actual bladder. The simulated bladder 150, via the filling tube 155 and the pump 160, is configured to expand via the injection of air when the user utilizes the pump 160. In various embodiments the filling tube 155 is a type of clear plastic tubing. In various embodiments, the pump 160 is a hand pump. The expansion of the bladder 150 using the pump 160 simulates the expansion of the bladder during a colpotomy procedure where the surgeon would introduce, for example, a saline solution to expand the bladder. In various embodiments, the simulated bladder 150 comprises electroconductive materials.

In various embodiments, the simulated bladder 150 may be formed using a balloon or an airtight or impermeable inflatable or fillable container (e.g., made from latex, polyolefin or the like) which is inserted after the simulated bladder 150 has been casted. In these embodiments, the balloon located inside the casted outer surface of the simulated bladder 150 provides an air-tight container or vessel to receive air or the like, e.g., via the pump and tubing, to inflate and thereby inflate the simulated bladder as a whole 150. The use of the balloon provides the ability for the casting or molding of the simulated bladder 150 to have less of an emphasis or concern that the outer surface or material of the simulated bladder 150 is uniform, impermeable and/or air-tight.

When the simulated bladder 150 is being cast within the mold, in various embodiments, additional materials may be placed at various portions of upper section of the simulated bladder 150. Such materials may include batting similar to embodiments that have the batting included at the simulated vaginal opening 105 for additional support. The added materials for the simulated bladder 150 provide additional structural support for the simulated bladder 150 as well as provides control and/or direction of the expansion of the simulated bladder 150. In various embodiments, the lower portion of the simulated bladder 150 is in contact with the connector 130, simulated vaginal canal 115, and/or the simulated vesicocervical space 135. When expanded, without the addition of materials for reinforcement, the simulated bladder 150 can expand towards the top of the colpotomy model. However, the upward expansion of the simulated bladder 150 may not be desired. The added materials (e.g., batting) into the top portion of the simulated bladder 150 or thickening of the silicone or the like in the top portion of the simulated bladder 150 can provide a simulated resistance to the expansion of the simulated bladder in the upward direction. Thus, when the simulated bladder 150 is expanded, expansion downwards towards the connector 130, simulated vaginal canal 115, and/or the simulated vesicocervical space 135 can be provided, e.g., more akin to the surgical procedure and/or the training thereof.

The simulated bladder 150, in various embodiments, is fixed within the colpotomy model 100 via the use of adhesives. In various embodiments, the simulated bladder 150 is fixed to the simulated pelvic frame 110 via the use of non-conductive adhesives, such as Loctite glue. In various embodiments, the simulated bladder 150 is fixed to the simulated peritoneum layer via the use of conductive adhesives, such as a chitosan glue.

FIG. 1B illustrates another view of the colpotomy model. In particular, FIG. 1B provides further details regarding additional materials or features that may be incorporated with the colpotomy model to provide additional support. In various embodiments, supportive structures can be incorporated/embedded into one or more of the elements of the colpotomy model. For example, the simulated vaginal opening may have batting embedded within at various locations. In addition, a reinforcement matrix or sleeve may be incorporated with the simulated cervix and the connector distally connected to the simulated cervix. In various embodiments, a heat-shrink tubing may be heat-shrunk around the connection point between the filling tube and the simulated bladder in order to enhance the connection between the two.

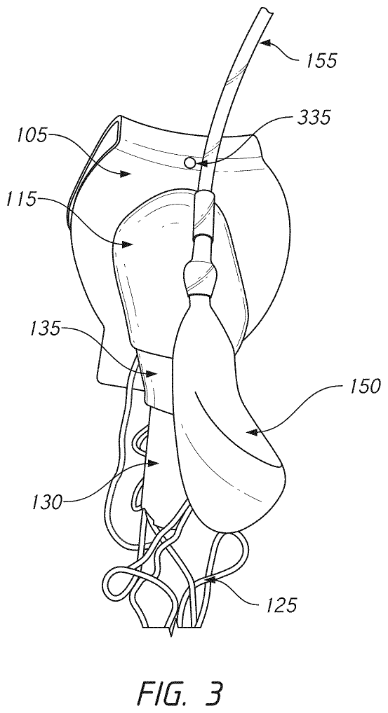

FIG. 3 illustrates the example components of the colpotomy model not connected to a simulated pelvic frame. In particular, the figure illustrates an inflatable bladder 150 connected to a filling tube 155 (and a pump which is not shown), a simulated vaginal opening 105, a simulated vaginal canal 115, a simulated vesicocervical space 135, a connector 130 connected to a portion of a simulated cervix, and one or more cords 125 connected to the connector 130. A portion of simulated cervix, not shown, is connected to the connector 130 and is housed or encased within an internal space defined by the simulated vaginal canal 115.

As noted above, the simulated bladder 150 is connected to the filling tube 155 that extends outside of the simulated pelvic frame of the colpotomy model. In various embodiments, the filling tube 155 extends through a dedicated hole 335 for the filling tube in the simulated vaginal opening 105. The dedicated hole 335 is located above the main opening of the simulated vaginal opening 105 which provides access to the simulated vaginal canal 115. The filling tube 155 is connected to the pump (e.g., hand pump) (not shown).

In various embodiments, the simulated vaginal opening 105, the simulated vaginal canal 115, the simulated cervix, the connector 130, and the simulated vesicocervical space 135 are formed together as a single structural or monolithic piece. In various embodiments, this is carried out via successive casting using several different molds. In particular, one mold may be used to cast the simulated vaginal canal 115 in connection with the simulated cervix and connector as a single monolithic structure. Once this cast is completed, the combined structure is introduced into another mold and the simulated vesicocervical space 135 is cast onto the simulated vaginal canal 115 and the simulated cervix. Another cast is then performed with the simulated vaginal opening 105 being casted on the previous combination. The result of these successive casts is the collection of components (e.g., the simulated vaginal opening 105, the simulated cervix, the simulated vesicocervical space 135, the connector 130, and the simulated vaginal canal 115) which are all connected to each other or formed as a single monolithic structure without the need for adhesives or other types of connective features to hold these components together. In various embodiments, the collection of components (e.g., the simulated vaginal opening 105, the simulated cervix, the simulated vesicocervical space 135, the connector 130, and the simulated vaginal canal 115) may be cast via separate molding processes and assembled together, for example, via the use of adhesives. In various embodiments, the connector and the simulated cervix are formed as a single monolithic structure.

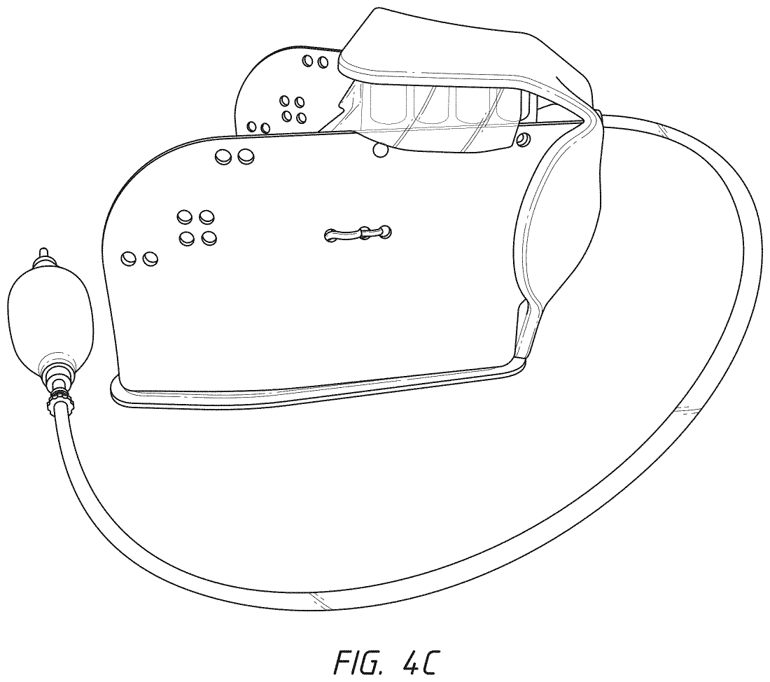

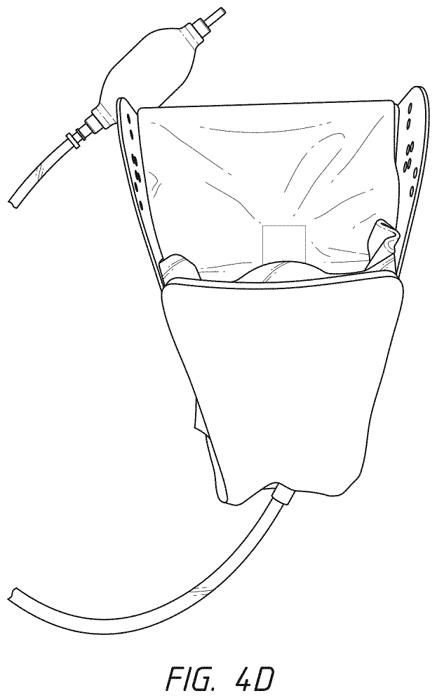

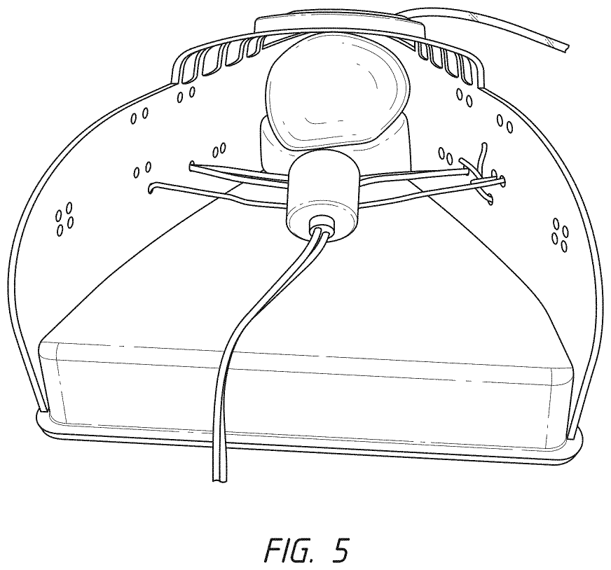

In various embodiments, the simulated vaginal opening is sized and/or shaped to provide an enlarged portion of the simulated vaginal opening to be folded over the top of the simulated pelvic frame. In some embodiments the simulated pelvic frame may have a cover which is spaced apart from and parallel with the base of the simulated pelvic frame. In various embodiments, the cover is attached to a proximal end of the simulated pelvic frame (as seen, for example, in FIG. 4D and FIG. 5). The enlarged portion of the simulated vaginal opening is attached to the cover. The enlarged or folded portion of the simulated vaginal opening is configured to provide a thick area of simulated electroconductive tissue, so positioned and suitable to physically and electrically contact a grounding pad that is removably connected to an electrosurgical generator.

With continued reference to FIG. 3, in various embodiments, the simulated cervix is connected to the simulated vaginal canal 115. In particular, the simulated cervix is so connected, such that the proximal end of the simulated cervix extends towards the main opening of the simulated vaginal opening 105. Meanwhile, the simulated cervix is distally connected to and/or distally extend to provide the connector 130 that extends towards the distal end of the colpotomy model. The user, in various embodiments, is directed to manipulate and maneuver the proximal end of the simulated cervix. As such, the simulated cervix and the simulated vaginal canal are movable relative to each other. In various embodiments, the connector 130 that is distally connected to and/or integrated into the simulated cervix is connected to one or more cords 125.

In various embodiments, the connector 130 comprises an elongate tube and, in various embodiments, is made of electroconductive material, and/or a reinforcement sleeve (e.g., mesh). The number and arrangement of cords 125 provides a suspension, movement and/or tension of the simulated cervix and simulated vaginal canal 115 that is not particularly anatomically correct (e.g., as a vaginal canal and/or cervix is held by any number of different tissue and/or organs such as a uterus and ligaments). The one or more cords 125 and/or connector 130, in various embodiments, allow for the overall colpotomy model to forgo various organs and/or tissues that would otherwise increase the complexity of the model. The simplification of the colpotomy model provides benefits in assembly, cost and waste reduction, as well as focuses the user's attention to the relevant portions of the model uniquely suited for learning, training, and practicing a colpotomy procedure.

With reference to FIG. 2E, another view of the simulated vaginal canal 115, simulated cervix 120, simulated vesicocervical space 135, and the connector 130 is shown. For example, the connector 130 is shown with an embedded reinforcement matrix (e.g., reinforcement sleeve material) 350. In addition, further details related to the simulated vesicocervical space 135 can also be seen. In particular, the simulated vesicocervical space 135 has a first layer 352, a second layer 354, and the interface material (e.g., silicone grease) 250 placed at various portions between the first layer 352 and the second layer 354.

With reference to FIG. 2F, another embodiment of the simulated vesicocervical space 135 is provided. In particular, the arrangement of the simulated vesicovaginal septa 260 is reduced such that the simulated vesicovaginal septa 260 does not extend along the entire length of the simulated vesicocervical space 135. Instead, additional interface material 250 is provided in between the two layers 352, 354 of the simulated vesicocervical space 135 past the simulated vesicovaginal septa 260. The added interface material 250 to the simulated vesicocervical space 135 provides more space within the layers 352, 354 of the simulated vesicocervical space 135 that are separable via the use of blunt dissection thereby expanding the plane of separation that the users (e.g., surgeons) would be able to work in during a simulated colpotomy procedure.

With reference to FIG. 4A-FIG. 4D, the figures illustrate different views (e.g., front, back, side, and top) of an embodiment of the colpotomy model. The colpotomy model provides a particular simulation model for the teaching, training, and/or practicing of a colpotomy procedure. In various embodiments, the components and arrangement of the components associated with the colpotomy model are not designed to be an exact replica of the human anatomy. Rather, in various embodiments, the colpotomy model includes those components which are useful for users to learn and practice a colpotomy procedure with, for example, tissues and/or organs not relevant being omitted (e.g., uterus). Some of the components of the model and/or portions thereof are provided so that users are able to recognize and become accustomed to interacting with various tissues and/or organs that are associated with a colpotomy procedure. For example, the simulated vaginal canal has its associated rugae provided as a useful anatomical marking or indicator that can direct the user as to where in the simulated vaginal canal the user should search for an incision point.

FIG. 4A illustrates the front or proximal end of the colpotomy model. From the front of the colpotomy model, one can see the simulated vaginal opening attached to a simulated pelvic frame, a filling tube, and a connected pump. The filling tube and pump are provided to allow for simulating the expansion of the bladder during a colpotomy procedure. The user uses the pump to introduce air (via the filling tube) into the simulated bladder so that the simulated bladder expands during the simulated colpotomy procedure. This act can correspond to a surgical practice in which surgeons introduce, for example, a saline solution to expand the bladder while performing the colpotomy procedure. For various alternative embodiments, replacement of the pump to provide other sources of liquids or gases for the purposes of simulating this step of the colpotomy procedure have also been contemplated. The filling tube is inserted into the colpotomy model via an opening in the simulated vaginal opening.

In addition to the filling tube and pump, FIG. 4A illustrates the simulated vaginal opening that is assembled on the simulated pelvic frame. The simulated vaginal opening provides access via a main opening to the simulated vaginal canal (not shown) which defines an internal space where the simulated cervix (not shown) can be grasped and maneuvered (e.g., pulled). In various embodiments, the simulated vaginal opening is attached to the simulated pelvic frame, for example, via the use of adhesives so that the simulated vaginal opening does not become dislodged from the simulated pelvic frame during use. In various embodiments, the simulated vaginal opening is removable from the simulated pelvic frame. This allows the simulated vaginal opening (and any of its associated attached components such as the simulated cervix, simulated vaginal canal, and simulated vesicocervical space) to be removed and replaced. In various embodiments, the simulated vaginal opening and associated components are designed to be single-use and/or disposable.

In various embodiments, especially where the colpotomy model is used in connection with simulating electrosurgery, a grounding pad may be attached to and/or incorporated with the simulated vaginal opening for the purposes of managing the electricity being used during the simulation. The grounding pad may be removably attached and/or in contact with at least a part of the surface of the simulated vaginal opening, for example, via a portion at the top of the colpotomy model. Other embodiments have been contemplated where the grounding pad may be incorporated with more or less of the surface of the simulated vaginal opening and at different locations along the simulated vaginal opening but not obscuring the main opening providing access to the simulated vaginal canal.

In various embodiments, the colpotomy model or portions thereof are made of electroconductive material (e.g. comprising an electroconductive hydrogel). In various embodiments, only the simulated cervix, simulated peritoneum layer, simulated vesicocervical space, simulated vaginal canal, and/or simulated vaginal opening are made of or comprises electroconductive material. In various embodiments, the simulated pelvic frame, the one or more cords, the filling tube and/or pump are not electrically conductive, insulated, and/or not made of an electrically conductive material thereby preventing or reducing potential damage and/or thermal spread and/or effects to other portions of the colpotomy model, surgical training device, and/or surrounding areas.

FIG. 4B illustrates the back or distal end of the colpotomy model. In particular, a layer is used to simulate the peritoneum layer located at the back of the pelvic frame. In various embodiments, the layer used to simulate the simulated peritoneum layer comprises of an electroconductive material. The simulated peritoneum layer is part of a simulated colpotomy procedure where the user would have to dissect in order to reach a simulated peritoneal cavity corresponding to the open space at the distal end of the colpotomy model behind the simulated peritoneum layer. To reach the simulated peritoneum layer, the user would needed to have already created an incision in the simulated vaginal canal and dissected through the simulated vesicocervical space.

In various embodiments, the simulated peritoneum layer covers the entirety of the back/distal end of the colpotomy model (e.g., from the top where the simulated vaginal opening is located with the simulated pelvic frame to the base of the simulated pelvic frame). Furthermore, access to the simulated bladder and the simulated cervix is completely occluded by the simulated peritoneum layer from the back or distal end of the colpotomy model as the edges of the simulated peritoneum layer are attached (e.g., via adhesives) to the sides and/or base of the simulated pelvic frame.

In various embodiments, portions of the simulated peritoneum layer are also attached (e.g., via conductive adhesives) to the simulated bladder and the connector. As illustrated in FIG. 1A, the attachment of the simulated peritoneum layer to the simulated bladder causes the simulated peritoneum layer to move based on the changes associated with the simulated bladder expanding and/or the connector/simulated cervix being moved. Similarly, a portion of the simulated peritoneum layer is attached (e.g., via conductive adhesive) to the connector and/or simulated cervix. As such, based on the current state of the simulated peritoneum layer, the user (while performing the simulated colpotomy procedure) would look for the point in the simulated peritoneum layer where the simulated peritoneum layer is reflected. The simulated peritoneal reflection corresponds to the portion of the simulated peritoneum layer which appears to be partly folded onto itself. In another way, from the simulated vaginal canal side of the colpotomy model, the simulated peritoneum layer has a portion that appears to be more convex as opposed to being concave. The simulated peritoneal reflection is the desired location where the user would dissect through the simulated peritoneum layer to access to the peritoneal cavity behind the simulated peritoneum layer and in turn avoid dissecting or accessing areas that are not desired such as the simulated cervix, connector, the simulated bladder, and/or areas surrounding the simulated bladder.

FIG. 4C illustrates the side of the colpotomy model. Aside from the simulated vaginal opening, the filling tube, and the pump which can be seen in the earlier FIG. 4A, this view of the colpotomy model shows various apertures associated with the simulated pelvic frame. In particular, the simulated pelvic frame has a first set of apertures located near the center outer surface. In various embodiments, the first set of apertures are used to suspend (in conjunction with the cords attached to the connector) the internal components of the colpotomy model that are housed within the simulated pelvic frame. In various embodiments, one (e.g., as in FIG. 6A) or more cords (e.g., as in FIG. 6B) can be used to suspend the internal components of the colpotomy model.

In an example embodiment, one cord is used to suspend the internal components of the colpotomy model within the simulated pelvic frame. As illustrated in FIG. 6A, a first end of the cord is tied to itself at an aperture of one of the walls of the simulated pelvic frame (1). The opposite end of the same cord extends through one end of the connector (2) in order to interface with apertures on the other wall of the simulated pelvic frame (3). The cord then exits the simulated pelvic frame out of one aperture and re-enters the simulated pelvic frame through a nearby aperture (4). Thus, from the outside view of the colpotomy model (as seen in FIG. 4C), the user would only see a portion of the cord (B) which obscure some of the apertures associated with the simulated pelvic frame. After re-entering the simulated pelvic frame, the cord can then extend through the opposite end of the connector (5) before being tied to itself at a nearby aperture on the same wall as the first end of the cord (6).

In various embodiments, the connector, simulated cervix and/or portions thereof are reinforced and/or tear resistant to withstand movement and/or support one or more cords extending therethrough and/or otherwise attached to the connector. In various embodiments, the connector comprises conductive tissue, e.g., comprising an electroconductive hydrogel, and embedded therein a reinforcement matrix or sleeve (e.g., a Kevlar knit tube or mesh), through which a cord is threaded through and/or attached thereto.

In various embodiments, the connector may be reinforced using a fiber-based support structure and, in various embodiments, is a yarn support structure, that is knitted, woven, and/or wrapped. An example embodiment of the yarn support structure is illustrated in FIG. 2G. In particular, FIG. 2G illustrates the yarn support structure within a mold prior to being incorporated into the connector.

The yarn can reduce stretching of the simulated cervix and/or connector as the user performs the simulated colpotomy procedure. Furthermore, embodiments using the yarn support structure can be customized by adjusting the type of yarn being used and the amount of yarn used. For example, more yarn can be used when constructing the yarn support structure to provide a higher percentage of fibers present with the same volume associated with the connector 130 and/or the simulated cervix 120. The changes in the percentage of fibers can be used to adjust the feel and stretchability of the connector and/or the simulated cervix to better simulate the colpotomy procedure.

In addition, by using yarn or the like, embodiments can be color coded by choosing yarn of any color. For example, in various embodiments the color of the yarn can be chosen to correspond with the color associated with the simulated cervix 120. This can allow the removal of a casting step when creating the colpotomy model since a separate step may no longer be needed to differentiate the colors between the interior of the simulated cervix 120 and the structures associated with the simulated vesicocervical space 135. As such, the yarn support structure can simplify manufacturing or reduce costs. In various embodiments, the color of the yarn can be chosen to be different/distinct from the color associated with the simulated cervix 120. The color difference allows for visual direction that could be used by the user to direct where to proceed for the simulated colpotomy procedure. The color difference with the yarn can be used, in the various embodiments, in place of any texture landmarks or other anatomical color schemes that would also direct the user how to proceed in a simulated colpotomy procedure. In various embodiments, the color difference in the yarn can be used in conjunction with the texture landmarks or anatomical color schemes to direct the user during the simulated colpotomy procedure.

FIG. 2H illustrates various steps associated with the creation of the yarn support structure prior to placing the yarn support structure to be molded with the connector 130 as illustrated in FIG. 2G. It should be noted that variations in the steps (other than what has been illustrated in the figure) have been contemplated, some of which will be raised below where applicable.

To provide the specific shape of the yarn support structure corresponding with the shape of the connector mold, a three-dimensional mandrel is formed. The three-dimensional mandrel, e.g., mandrel 292, is designed to hold the strands of yarn in place as the yarn support structure is being assembled (e.g., knitted, woven, braided, and/or wrapped). The three-dimensional mandrel may be formed via two or more separate two-dimensional components 290. The two-dimensional components are then connected to form the three-dimensional shape for the mandrel 292 corresponding to the shape that the yarn support structure will have.

In the embodiment illustrated in FIG. 2H(1), the two-dimensional components 290 have corresponding slits which extend partially through the middle of each component. This allows the two corresponding components to come together and maintain a shape without the use of adhesives. Other embodiments may utilize a different number of separate components (two or three-dimensional) that are connected in different ways to form the three-dimensional mandrel as illustrated in FIG. 2H(2), e.g., mandrel 292. For example, two-dimensional components may be glued together to form the three-dimensional mandrel. In a different embodiment, a plurality of three-dimensional sections can be stacked one upon another in order to form the three-dimensional mandrel. Furthermore, in various embodiments, the mandrel may be a three-dimensional monolithic structure.

In various embodiments, the cross-section of the three-dimensional mandrel is a “plus-sign” created by the two two-dimensional components 290 connected together. In other embodiments, a plurality of two-dimensional components can be provided that, when connected, provide a different cross-section for the three-dimensional mandrel, such as a grid. Based on the shape (and corresponding cross-section of the three-dimensional mandrel), the arrangement of the yarn can be controlled and/or how much yarn is present within the yarn support structure. By changing the arrangement and volume percentage of yarn, fiber or the like included with the yarn or fiber support structure, the stretchability and firmness of the connector 130 can be adjusted with the yarn or fiber support structure being embedded therein.

Once the three-dimensional mandrel is formed, in various embodiments, the strands of yarn are then arranged onto the three-dimensional mandrel. In one embodiment, the strands are longitudinally wrapped around one of the sides (e.g., plus sign extensions) associated with the three-dimensional mandrel, as illustrated, for example, in FIG. 2H(3). This is continued, in various embodiments, until each of the sides of the three-dimensional mandrel are covered underneath the yarn, as illustrated, for example, in FIG. 2H(4).

After each of the sides of the three-dimensional mandrel are covered in the longitudinal direction, the yarn, in various embodiments, is wrapped along the cross-section of the three-dimensional mandrel along the entire length of the three-dimensional mandrel, as illustrated, for example, in FIG. 2H(5). After being completed, the yarn support structure will have an interior arrangement of yarn surrounded by an outer layer of yarn. In various other embodiments, other arrangements may also be possible (e.g., reversing or alternating the horizontal and longitudinal arrangement of yarn).

Once the yarn support structure has been formed on the three-dimensional mandrel, the yarn support structure and the three-dimensional mandrel is placed into the mold (as illustrated in FIG. 2G) to be cast within the connector 130. In various embodiments, a material used to cast the connector 130 may be a conductive material. After the casting of the connector 130 (and the lower part of the simulated vesicocervical space 135), there may be various exposed fibers associated with the yarn support structure as well as the three-dimensional mandrel. If left in its current state, the connector 130, although usable, may not be ideal as the excess yarn and/or three-dimensional mandrel material could confuse the user and potentially interfere with the simulated colpotomy procedure. Once the material for the connector 130 is cured (thereby encasing the majority of the yarn support structure therein), the excess yarn can be removed to correspond to the outer surface of the connector.

In addition to removing the excess yarn, the three-dimensional mandrel can also be removed from within the connector 130. In some embodiments, if the three-dimensional mandrel is made of a plurality of two-dimensional or three-dimensional components, the separate components can be dissembled and removed individually. In other embodiments, the yarn can be arranged around the three-dimensional mandrel so that the three-dimensional mandrel can be slipped out from the interior of the connector 130 once the material forming the outer surface or portion of the connector 130 has cured. In some embodiments, portions of the yarn may be cut from the interior of the yarn support structure that holds the three-dimensional mandrel in place thereby releasing the three-dimensional mandrel so that it can be removed.

Once the three-dimensional mandrel has been removed, in various embodiments, the interior of the yarn support structure can be filled with additional yarn or other materials to provide more support/structure to the connector 130. In various embodiments, the interior of the yarn support structure may be left empty.

In various embodiments, two or more cords are used to suspend the connector, simulated vaginal canal and/or simulated cervix. For example, as illustrated in FIG. 6B, each of the cords (at one end) are connected at different points of the connector distally connected to the simulated cervix (X). The other ends (Y) of each of the cords loop with different apertures and are tied to themselves to secure the cords to the simulated pelvic frame. In various embodiments, one end of a cord, e.g., a proximal and/or a distal cord, is attached or connected to a first wall of the simulated pelvic frame and the cord extends or is threaded through the connector to a second or opposing wall of the simulated pelvic frame in which the other end of the cord is attached thereto. The cord is attached to wall of the pelvic frame, in various embodiments, via threading the cord through adjacent openings or apertures and then knotted.

In various embodiments, the cords extend perpendicular to the direction of the connector and remains generally parallel with the base of the simulated pelvic frame. In various embodiments, the free end of the cord(s) can then be “looped” with the apertures of the pelvic frame whereby the free end of the cords exit the interior of the pelvic frame from one aperture and re-enters the pelvic frame from a nearby aperture. Each of the cords, in various embodiments, are generally positioned equidistant from each other with respect to the length of the entire connector with the position of the cords on one side of the connector mirroring the other side of the connector. Internally, the cords can be affixed to itself or to the connector, for example, via the use of adhesives. In various embodiments, portions of the cord can be threaded through and/or embedded into the connector. In various embodiments, the cords can be knotted or tied near the aperture in order to secure the cord to the simulated pelvic frame. In various embodiments, the tautness/elasticity of the cords can be adjusted thereby similarly affecting the suspension and the movement of the simulated cervix within the simulated pelvic frame.

In various embodiments, the cord is made of a continuous length of fibers or filaments. In various embodiments, the cord is made of a monofilament fiber. In various embodiments, the cord comprises a yarn and/or nylon. In various embodiments, the cord is compliant thereby permitting flexing, bending, and/or movement of itself. In various embodiments, the cord is tear resistant. In various embodiments, the cord has a tensile, longitudinal, and/or transverse strength greater than the connector, the simulated cervix, and/or the simulated vaginal canal. In various embodiments, the simulated pelvic frame or portions thereof are more rigid and/or has a tensile strength greater than the cord. In various embodiments, the cord may be incorporated into, attached and/or extend from the yarn support structure and/or be a monolithic extension or a continuation of the yarn or fiber of the yarn support structure.

In various embodiments, the simulated pelvic frame may include a plurality of other apertures at other locations (e.g., the sides of the outer surface B of the simulated pelvic frame wall as seen in FIG. 4C). These apertures can be used to similarly suspend other additional organs or tissue not described in this disclosure but can be added at a later time thereby allowing the present colpotomy model to be usable for other simulated surgical procedures. These apertures can also be used to secure the pelvic frame to the surgical training device. In various embodiments, the simulated cervix and other components (e.g., simulated vaginal canal) can be suspended using one or more of these other apertures and thus some of the apertures shown may be removed/not included.

FIG. 4D illustrates the top of the colpotomy model. From this view of the colpotomy model, in various embodiments, a portion of the simulated vaginal opening is shown to be placed across the top of the simulated pelvic frame that sits above the simulated vaginal canal and the simulated cervix and, in various embodiments, participates in and/or creates an enclosed space. In various embodiments, the grounding pad may be adhered with or otherwise attached to this portion of the simulated vaginal opening.

Also, from this top view of the colpotomy model, a view of the overall shape of the simulated pelvic frame can be seen. In particular, the simulated pelvic frame has a conical or frusto-conical shape corresponding to the distal end being generally wider than the proximal end. Furthermore, the simulated pelvic frame has two side walls which are perpendicular to the base. The interior of the simulated pelvic frame (between the two side walls) is generally open between the distal end and the proximal end.

In various embodiments, the top of the simulated pelvic frame may include a top cover which is parallel to the base and at least partially covers the interior of the simulated pelvic frame. The top cover can be used to secure the simulated vaginal opening and/or the grounding pad in a position above the internal components of the colpotomy model.

FIG. 5 illustrates internal components of the colpotomy model arranged within the simulated pelvic frame. In particular, the figure illustrates an embodiment of the colpotomy model from the distal end without the simulated peritoneum layer obscuring the internal components of the colpotomy model. In various embodiments, the simulated peritoneum layer is removable and replaceable.

In various embodiments, the cords are arranged in a pre-defined manner in order to allow the simulated cervix to move back and forth in response to the user's grasping and movement of the simulated cervix within the simulated vaginal canal. As seen in the figures, the cords are generally attached at the connector such that the cords are spaced identically on both sides of the connector. In addition, the cords are arranged substantially parallel with the base of the simulated pelvic frame. Furthermore, the cords have a pre-defined tautness and/or elasticity such that the connector maintains a pre-determined height above the base of the simulated pelvic frame and/or movement within the frame and/or relative to other portions of the colpotomy model.

In various embodiments, as illustrated in the FIG. 5, the colpotomy model may also include a grounding cable removably attached to the colpotomy model, e.g., at the end of the connector that is distally connected to the simulated cervix with another end of the cable removably attached to an electrosurgical generator. If the colpotomy model is being used via only cold-cutting devices (i.e. not electrosurgery), the grounding cable can be removed and/or a ground pad may not be attached to or in contact with the model.

In various embodiments, cables and/or ports may be associated with a part of the colpotomy model that would be adapted to receive other cables and/or ports used for managing the electrosurgical energy. The features for the cables and/or ports may be cast as part of the colpotomy model.

The grounding cable, in being attached to the connector, may not be desired in various embodiments as the grounding cable itself may interfere with the movement of the simulated cervix, which in turn may affect the user's ability to identify where the “rolling” of the simulated vaginal canal occurs. Also, the use of the grounding cable internal to the patient is not a typical representation of traditional management of electrosurgical energy during performance of an electrosurgical procedure.

Alternative embodiments have also been contemplated where removable grounding pads can be attached directly to the connector instead of the use of the grounding cable. However, similar to the use of the grounding cable described above, the suspension and associated movement of the simulated cervix may be affected.

In various embodiments, selection of a portion of the simulated vaginal opening (e.g., the top cover) provides a sufficient area for an electrical connection. Therefore, the implementation of the grounding pad may be desired as such a location so as to not interfere with user operation with other portions of the colpotomy model (e.g., the movement of the simulated cervix/vaginal canal and/or distracting the user).

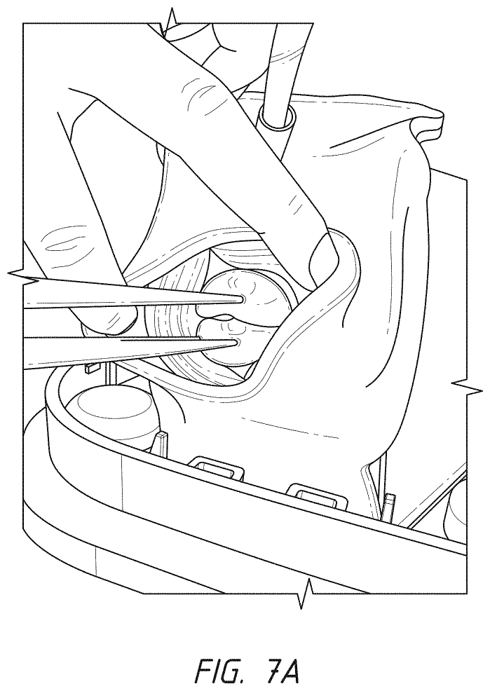

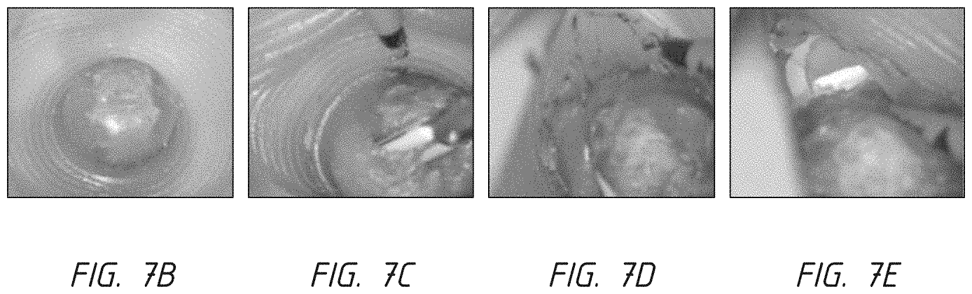

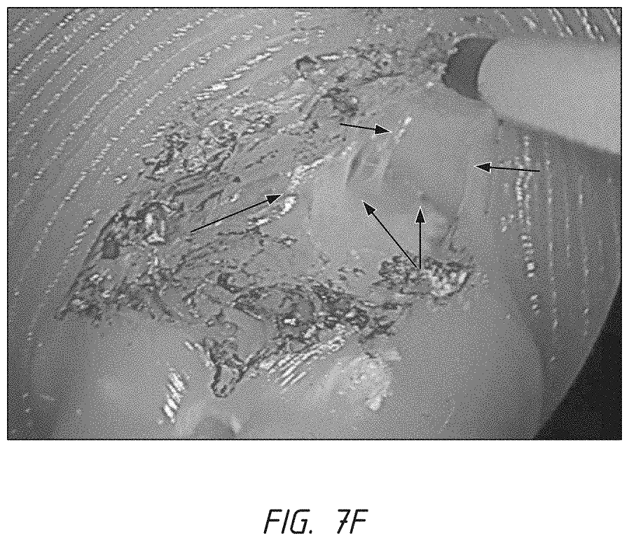

With reference to FIG. 7A-7E, various steps of the colpotomy procedure (as described above) are described in connection with the use of the colpotomy model. In FIG. 7A, the user can simultaneously retract the main opening in the simulated vaginal opening while grasping/maneuvering the simulated cervix (positioned inside the simulated vaginal canal) back and forth in order to identify where to place the incision in the simulated vaginal canal. The location of the incision is useful so as not to accidentally penetrate into tissue and/or organs (such as the cervix, uterus, or bladder) which is not desired. Generally, the point of interest is located past the rugae of the simulated vaginal canal in the area where the simulated vaginal canal is smooth. The rugae, as illustrated in FIG. 7B, correspond to consecutive ridges in the simulated vaginal canal. As the cervix is moved, a portion of the tissue of the vaginal canal rolls which corresponds to where the tissue becomes concave near the simulated cervix. The point where the tissue of the vaginal canal rolls is where the incision will be made. FIG. 7C illustrates an example scenario of the user performing the incision in the tissue of the simulated vaginal canal near the simulated cervix. Having a simulated cervix which is stationary or not as easily movable or manipulatable in such a way would not be ideal for the identification of the target area in the vaginal canal as this can make identifying the target area for the incision more difficult if not at all possible.

After the point of incision is identified, the user then makes the incision through the vaginal mucosa of the simulated vaginal canal. The user proceeds past the incision in the simulated vaginal canal and enters the simulated vesicocervical space as seen in FIG. 7D. The user then begins dissecting through the simulated vesicocervical space.

As illustrated in FIG. 2D, the simulated vesicocervical space has a plane of separation which the user follows which leads to the distal portion of the colpotomy model towards the simulated peritoneum. This plane of separation of the simulated vesicocervical space has layers which are separable using blunt dissection. FIG. 7F provides an illustration of the user dissecting through the plane of separation. In areas where the interface material (e.g., silicone grease) is located, the two layers are able only partially, temporarily and/or removably adhered and are able to be peeled apart using blunt dissection. The portions where no interface material is located, the two layers come together to form a cohesive strip (corresponding to the septum) that can only be separated by sharp dissection (e.g., snipping). The peeling action when separating the two partially-adhered layers corresponds to the feel of separating tissue in the corresponding area in the human anatomy.

After exiting the simulated vesicocervical space, the user seeks to identify the location of the simulated peritoneal reflection (see FIG. 1A) located on the simulated peritoneum layer. The simulated peritoneal reflection generally corresponds to a point in the simulated peritoneum layer which is convex (e.g., partly folded onto itself). When identified, the user is instructed to create an incision through the simulated peritoneal reflection to access the simulated peritoneal cavity located past the simulated peritoneum layer. Completion of this dissection is shown for example in FIG. 7E.

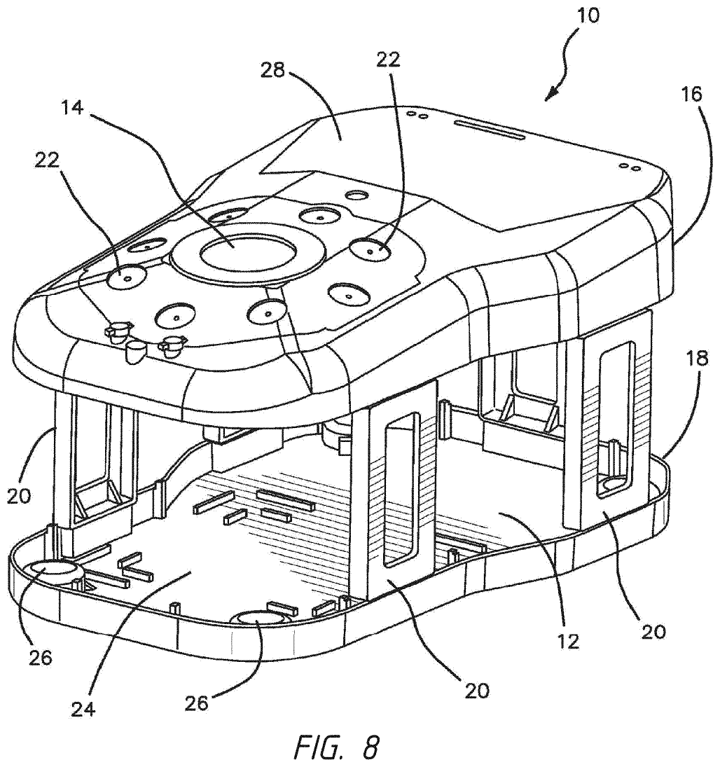

In various embodiments, a surgical training device 10 is configured to receive one or more simulated tissue, organs, or models for the purposes of simulating laparoscopic surgical procedures performed within a patient. In the context of the present application, with reference to FIG. 8, the surgical training device 10 would be configured to receive the colpotomy model described above. FIG. 8 is a top perspective view of an exemplary surgical training device. The surgical training device 10 is particularly well suited for practicing laparoscopic or other minimally invasive surgical procedures. That is because the surgical training device 10 is configured to simulate conditions associated with laparoscopic procedures such as the torso/abdominal region of a patient. One feature that facilitates the simulation of the conditions associated with laparoscopic procedures is that the surgical training device 10 can be set up to obscure a user's direct vision of simulated tissues, model organs, and/or training models being practiced on that are housed within the surgical training device 10.

With continued reference to FIG. 8, the surgical training device 10 provides a body cavity 12 substantially obscured from the user that is configured to receive the simulated tissues, model organs, and/or training models of the like described in this invention. In some embodiments, the body cavity 12 is accessible via a tissue simulation region 14 that is penetrated by the user employing surgical instruments (e.g., laparoscopic devices) to practice surgical techniques on the simulated tissues, model organs, and/or training models found located in the body cavity 12. In various embodiments, the body cavity 12 can also be accessible through a hand-assisted access device or single-site port device that is alternatively employed to access the body cavity 12. In various embodiments, the body cavity 12 can be accessible via both the tissue simulation region 14 and the hand-assisted access device or single-site port device. An exemplary surgical training device is described in U.S. patent application Ser. No. 13/248,449 entitled “Portable Laparoscopic Trainer” filed on Sep. 29, 2011 and incorporated herein by reference in its entirety.

To obscure the body cavity 12 from the user, the surgical training device 10 is designed to have a top cover 16 that is connected to and spaced apart from a base 20 by at least one leg 20. In various embodiments, the surgical training device 10 may have more than one leg 20. With the top cover 16, the base 20, and the at least one leg 20, the surgical training device 10 is configured to simulate laparoscopic conditions whereby the body cavity 12 is obscured from a user's direct vision. Such laparoscopic conditions may correspond to procedures that pertain to the user (e.g., surgeon) operating on tissues or organs that reside in an interior of a patient (e.g., body cavity) such as the abdominal region. Thus, the surgical training device 10 is a useful tool for teaching, practicing, and demonstrating surgical procedures with their related surgical instruments by simulating a patient undergoing the surgical procedures.

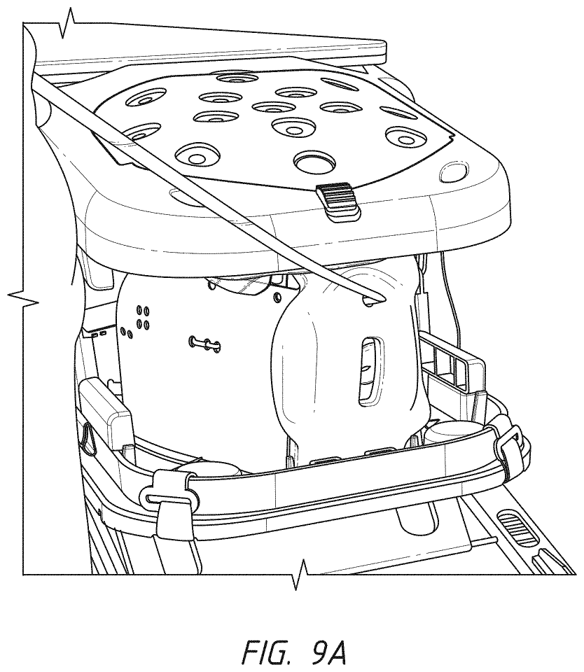

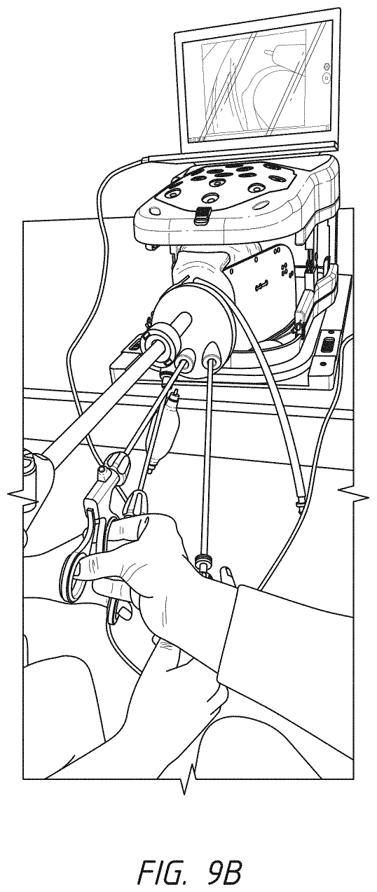

As described above, the surgical instruments are inserted into the body cavity 12 through one or more tissue simulation regions 14 as well as through pre-established apertures 22 via hand-assisted access devices or single-site port devices located in the top cover 16 of the surgical training device 10. Although openings may be pre-formed in the top cover 16, various surgical instruments and techniques can also be used to penetrate the top cover 16 in order to access the body cavity 12 thereby allowing for further simulation of surgical procedures. Once inside the body cavity 12, the user is then able to perform simulated surgical procedures with simulated tissue, organs, or models that are located in the body cavity 12 between the top cover 16 and the base 18. FIG. 9A illustrates an example embodiment of the surgical training device 10 being used to house the colpotomy model (as described above in the present application) that is designed for the teaching, practice, and demonstration of the colpotomy procedure.

With reference back to FIG. 8, in various embodiments, the simulated tissue, organ, or model is secured beneath one or more of the tissue simulation region 14 or apertures 22 located in the top cover to ensure that the simulated tissue, organ, or model does not move while the surgical training device 10 is in use. To secure the one or more simulated tissues, organs, or models located in the body cavity 12, the base 18 may be designed to have a model receiving area 24 or tray that is configured to stage or secure the simulated tissue, organ, or model in place within the surgical training device 10. In various embodiments, the model receiving area 24 of the base 18 may include frame-like elements for holding the simulated tissue, organ, or model in place. The frame-like elements would interface with at least a part of the simulated tissue, organ, or model (e.g., bottom) and prevent the simulated tissue, organ, or model from moving or shifting around while the surgical training device 10 was in use. In various embodiments, the simulated tissue, organ, or model is removable and interchangeable with other simulated tissue, organ, or model as the frame-like elements are configured to accept multiple different types of simulated tissues, organs, or models.

In other embodiments, with continued reference to FIG. 8, the simulated tissue, organ, or model can also be secured via a clip attached to a retractable wire. In particular, the retractable wire and clip can be provided at various locations (e.g., 26) within the body cavity 12 associated with the model receiving area 24. The retractable wire is extendable from the various locations (e.g., 26) in order to allow for the clip to be attached to the simulated tissue, organ, or model. The retractable wire is then allowed to become taut thereby securing the simulated tissue, organ, or model. Similarly, in various embodiments, the retractable wire and clip allows for a removable connection between the base 18 and the simulated tissue, organ, or model. The retractable wire and clip are adapted to secure various different simulated tissue, organ, or model within the body cavity 12 where each simulated tissue, organ, or model may have different sizes and shapes.

Other means for securing the simulated tissue, organ, or model within the body cavity 12 are also contemplated. For example, the simulated tissue, organ, or model may be secured to the base 18 via the use of a patch of hook-and-loop type fastening material such as VELCRO® which allows for the simulated tissue, organ, or model to be removably connected to the base 18. Other embodiments may utilize other attachment methods which may not provide removable connectivity between the base 18 and the simulated tissue, organ, or model. For example, adhesives can also be used to provide more connections between the base 18 and the simulated tissue, organ, or model that are not easily removable.

In various embodiments, a video display monitor 28 is provided with the surgical training device 10. For example, the video display monitor 28 can be hinged to the top cover 16 and have at least two different orientations: a closed orientation where the video display monitor 28 is hidden and an open orientation where the user can view the video display monitor 28. In various embodiments the video display monitor 28 can be separate from the top cover 16 but still communicatively connected with the surgical training device 10.

In various embodiments, the video display monitor 28 is communicatively connected to a variety of visual systems that deliver an image to the video display monitor 28. For example, a laparoscope inserted through one of the pre-established apertures 22 or an image capturing device (e.g., webcam) located in the body cavity 12 can be configured to capture images of the simulated procedure being performed by the user and transfer the captured images back to the video display monitor 28 and/or other computing devices (e.g., desktop, mobile device) so that the user is able to view the area within the surgical training device 10. In various embodiments, other devices (e.g., microphones, sensors) may also be usable with the surgical training device 10 in order to capture other types of data such as audio data which can be combined with the visual data and displayed on the video display monitor 28.

The surgical training device 10 can be configured to receive portable memory storage devices such as flash drives, smart phones, digital audio or video players, or other digital mobile devices that further facilitate in the recording of the simulated surgical procedure and/or playback of the data obtained from the surgical training device 10 onto a monitor for demonstration purposes. In various embodiments, additional or alternative (e.g., larger) audio visual devices can be connected to the surgical training device 10 that are usable to display the audio visual data obtained from the surgical training device 10. In various embodiments, the surgical training device 10 may be communicatively connected (e.g., wired or wireless) to a different computing device (e.g., desktop, laptop, mobile device) which is configured to receive data obtained from the surgical training device 10 and display that data for others to view. Such embodiments may be useful in variations of the surgical training device 10 which do not include the video display monitor 28.

As illustrated in FIG. 8, the top cover 16 is generally positioned directly over the base 18 with the one or more legs 20 located substantially around the periphery. The legs 20 interconnect between the top cover 16 and base 18. In embodiments where there are two or more legs 20, each of the legs may be spaced apart equidistance from each other and act as a structural support holding the top cover 16 in place above the base 18. In various embodiments, the top cover 16 and the base 18 are substantially the same shape and size and have substantially the same peripheral outline. In various embodiments, the shape may correspond to the shape of the human anatomy such as the torso/abdominal region of a patient.

Depending on the arrangement of the top cover 16, base 18, and the one or more legs 20, in various embodiments, the body cavity 12 may be partially or entirely obscured from the user's view. In some variations, the legs 20 may include openings to allow ambient light to illuminate the body cavity 12 as well as provide weight reduction for the overall surgical training device 10. Apertures associated with the legs 20 may also allow user vision and/or access into the body cavity 12 of the surgical training device 10.

In various embodiments, the top cover 16 is removable from the one or more legs 20. In addition, in various embodiments, each of the legs are removable or collapsible with respect to the base 18. These features allow users to convert the surgical training device 10 into a portable form which has a reduced height.

As discussed above, the surgical training device 10 is configured to receive the colpotomy model with the purpose of simulating laparoscopic conditions helpful for simulating surgical procedures performed within a patient. As seen in FIG. 9A, an embodiment of the surgical training device 10 is being used to house the colpotomy model. As discussed above, the colpotomy model is designed to allow users, e.g., surgeons, to identify relevant anatomical landmarks and thereby learn how to perform the colpotomy procedure based on what is shown. Furthermore, the colpotomy model is designed to provide feedback and/or responses to user interaction with the colpotomy model that are similar to responses that would occur in the performance of an actual colpotomy procedure.

In various embodiments, the colpotomy model is also designed to be compatible with cold-cutting devices, e.g., non-electrosurgical devices, as well as electrosurgical devices. As such, the colpotomy model can be used to simulate electrosurgical procedures, non-electrosurgical procedures or a combination thereof.

FIG. 9B illustrates an embodiment of the surgical training device 10 that houses the colpotomy model while being utilized in simulating the colpotomy procedure. In particular, users would utilize different surgical instruments (e.g., laparoscopes, graspers, dissectors) in order to perform different surgical tasks with the colpotomy model inside the surgical training device 10 to perform the colpotomy procedure. For example, one or more surgical instruments may be used to provide vision of the colpotomy model located within the surgical training device 10. Furthermore, one or more instruments may be used to manipulate the various features of the colpotomy model, which may include but would not be limited to moving parts of the colpotomy model in order to identify where a requisite incision should be performed and performing the incision at a desired location.

In accordance with various embodiments, models are described herein that are designed to teach and allow users to practice how to perform a colpotomy procedure. The present disclosure describes the various embodiments of the colpotomy model.

In accordance with various embodiments, a colpotomy model comprises a simulated vaginal opening, a simulated pelvic frame, a simulated vaginal canal, a simulated cervix, a simulated vesicocervical space, a simulated peritoneum layer, a connector, and/or a simulated bladder. In a further embodiment, a filling tube and a pump may be connected to the simulated bladder to allow a user to inflate the simulated bladder.

In various embodiments, the colpotomy model may be compatible with electrosurgical simulations. As such, the colpotomy model may have one or more features comprise conductive materials such as the simulated vaginal opening, simulated vaginal canal, the simulated cervix, the simulated vesicocervical space, the simulated peritoneum layer, the connector, and/or the simulated bladder. Furthermore, one or more features may comprise non-conductive materials such as the simulated pelvic frame. In addition, the colpotomy model may further comprise a grounding element that is useful for managing electrosurgical energy used in an electrosurgical simulation. In various embodiments, the grounding element may be a grounding pad that is attached to a portion of the simulated vaginal opening. In various embodiments, the grounding element may be a grounding cable attached to a different portion of the colpotomy model such as the connector.

In various embodiments, the simulated pelvic frame houses the internal features of the colpotomy model. In various embodiments, the simulated pelvic frame has a conical or frusto-conical shape such that a proximal end of the simulated pelvic frame is narrower than the distal end of the simulated pelvic frame. In various embodiments, the simulated pelvic frame has at least two side walls having a plurality of apertures (or openings). The at least two side walls are perpendicular with a base of the simulated pelvic frame. In various embodiments, the interior of the simulated pelvic frame is generally open in between the at least two side walls. In some embodiments, the simulated pelvic frame may have a cover that is spaced apart from the base at the opposite end of the side wall. The cover may generally enclose a portion of an internal space of the simulated pelvic frame. In various embodiments, the cover may be used to attach and hold the simulated vaginal opening and/or the grounding pad.

In various embodiments, the colpotomy model comprises a simulated vaginal opening that encloses a proximal end of the simulated pelvic frame. The simulated vaginal opening has at least one opening that provides access to the simulated vaginal canal. In various embodiments, the simulated vaginal opening comprises a portion that is adapted to receive a grounding pad thereby configuring the colpotomy model to be compatible with electrosurgical instruments. In various embodiments, the simulated vaginal opening comprises batting embedded therein for support.

In various embodiments the simulated vaginal canal comprises two distinct sections. A first section of the simulated vaginal canal has a plurality of rugae which is represented via ridges. The first section starts at the proximal end of the simulated vaginal canal and ends where a second section starts. The second section of the simulated vaginal canal is smooth (i.e. has nor ridges). The second section is located near a simulated cervix that extends into an interior spaced defined by the simulated vaginal canal from a distal end of the simulated vaginal canal. In various embodiments, the simulated vaginal canal is tubular or cylindrical having an open proximal end and a distal end in which a simulated cervix is attached and/or extends therethrough. In various embodiments, the simulated vaginal canal comprises a plurality of circumferential ridges providing mountains and valleys disposed throughout the length of the simulated vaginal canal.

In various embodiments, the proximal end of the simulated cervix extends into the internal space of the simulated vaginal canal. In various embodiments, the proximal end of the simulated cervix is dome or hemispherical shaped and extends distally into a tubular or cylindrical shape. The distal end of the simulated cervix is connected to a connector or is formed into a connector which is configured to receive one or more cords. The connector and the one or more cords are provided in order to suspend the simulated cervix and allow the simulated cervix to be moved back and forth (e.g., “rolling” motion). When the simulated cervix is “rolled,” in various embodiments, portions of the simulated vaginal canal reflect (e.g., fold) onto itself. The reflections of the tissue associated with the simulated vaginal canal near the simulated cervix correspond to an area that the user would introduce an incision in order to access other portions of the model described below.

In various embodiments, a connector or support is distally connected to or integrated into or with the simulated cervix. The connector extends from the simulated cervix towards the distal end of the colpotomy model. In various embodiments, the connector is configured to be connected to one or more cords that are provided to suspend and facilitate the movement, e.g., elastic movement and/or tautness of the simulated cervix. In various embodiments, the cords may be threaded through the connector. The cords extend parallel compared to a base of the simulated pelvic frame. The cords are configured to interface with the sidewalls of the simulated pelvic frame in order to provide the suspension and/or movement of the simulated cervix. In various embodiments, the cords “loop” with apertures associated with the sidewalls of the simulated pelvic frame. In various embodiments, the connector comprises an embedded reinforcement matrix that provides support that is useful when the one or more cords are threaded through the connector. In various embodiments, the connector is configured to receive a grounding cable.

In various embodiments, the connector includes an embedded reinforcement matrix or sleeve. made of Kevlar or mesh. In other embodiments, the connector may include a constructed yarn or fiber support structure. The yarn support structure is formed by wrapping strands of yarn around a three-dimensional mandrel. Once arranged around the three-dimensional mandrel, the yarn support structure is cast alongside/within the connector thereby embedding the yarn support structure. Excess yarn and the three-dimensional mandrel are removable after the material is cured. The embedded reinforcement matrix, sleeve or yarn or fiber support structure provides varying degrees of tensile resistance/stretchiness and firmness to the connector.

In various embodiments, the simulated vesicocervical space comprises at least two layers. In between the layers, an interface material such as silicone grease is provided in various locations that provides the layers, in those locations, partial adherence to each other. The locations also correspond to a plane of dissection that can be peeled apart using blunt dissection. The locations where no interface material such as silicone grease is provided, the layers are attached together to form a cohesive strip or portion (corresponding to one or more vesicovaginal septum). The user dissects the simulated vesicocervical space along the plane of dissection in order to reach the simulated peritoneum layer. In various embodiments, the vesicovaginal septum may extend from one end of the simulated vesicocervical space near the simulated vaginal canal to the other end of the simulated vesicocervical space near the simulated peritoneum layer.

In various embodiments, the simulated vesicocervical space may be cast as two separate steps with the first step having the lower portion of the simulated vesicocervical space casted onto the connector and a second subsequent step having the top portion of the simulated vesicocervical space casted onto the lower portion of the simulated vesicocervical space. In other embodiments, the lower portion of the simulated vesicocervical space may be casted along with the connector with a subsequent step casting the top portion onto the lower portion; the latter embodiments removing or avoiding a separate casting step.

In various embodiments, the simulated vaginal opening, the simulated vaginal canal, the simulated cervix and connector, and the simulated vesicocervical space are cast as a single monolithic structure. In various embodiments, the same elements may be cast as separate components and assembled together, for example, via the use of adhesives.

In various embodiments, the simulated peritoneum layer is positioned at the distal end of the colpotomy model connected to at least the simulated pelvic frame, the simulated bladder, and a connector that is distally connected to the simulated cervix. Based on the movements of the simulated bladder and/or the connector, portions of the simulated peritoneum layer may reflect corresponding to a point in the simulated peritoneum layer that a user will create an incision. In various embodiments, the simulated peritoneum layer comprises electroconductive materials.

In various embodiments, a simulated bladder is provided that is configured to expand during the simulated colpotomy procedure to replicate the expansion of the bladder with a saline solution during an actual colpotomy procedure. The simulated bladder is expanded via the use of a filling tube and pump that is connected to the simulated bladder. The user is able to use the pump in order to fill the simulated bladder with air thereby expanding the simulated bladder.

In various embodiments, the simulated bladder may be cast as an expandable structure or envelope which is configured to receive air or the like used to simulate the expansion of the bladder during the colpotomy procedure. In various embodiments, the simulated bladder may include a balloon or a fillable or inflatable container which is inserted into the expandable structure. The balloon provides an air-tight or impermeable container for air or the like to be used to simulate the expansion of the bladder. In various embodiments, the simulated bladder may include additional materials in the top portion of the simulated bladder. The additional materials (embedded therein or otherwise attached) provides resistance associated with the expansion of the simulated bladder thereby directing the direction of the simulated bladder in the opposite direction of where the additional materials are located.

In various embodiments, the colpotomy model is configured to be received and housed within a surgical training device. The surgical training device simulates laparoscopic conditions thereby allowing a user to simulate a colpotomy procedure laparoscopically. In various embodiments, the surgical training device comprises a base, a cover, and one or more legs that are used to define an internal space that is generally obscured from a user's vision. In various embodiments, laparoscopic tools, sensors, or image capturing devices are used to capture audiovisual data inside the surgical training device. A display screen or other connected computing devices are provided that allows users to view the captured audiovisual data from inside the surgical training device.

Although the present invention has been described in certain specific aspects, many additional modifications and variations would be apparent to those skilled in the art. It is therefore to be understood that the present invention may be practiced otherwise than specifically described, including various changes in the size, shape, and materials, without departing from the scope and spirit of the present invention. For example, one of ordinary skill in the art should be able to use the examples to derive a variety of different implementations which retain the main functionalities of the surgical training systems described throughout the present disclosure. Although some of the embodiments utilize descriptions which are specific to structural and/or method-related steps, it is to be understood that such subject matter are not necessarily limited to the specifics (e.g., functionality for a feature can be distributed differently over more than one component or be performed in a combination of components different from what was identified explicitly above). Thus, embodiments of the present invention should be considered in all respects as illustrative and not restrictive.

The above description is also provided to enable any person skilled in the art to make and use the devices or systems and perform the methods described herein and sets forth the best modes contemplated by the inventors of carrying out their inventions. Various modifications, however, will remain apparent to those skilled in the art. It is contemplated that these modifications are within the scope of the present disclosure. Different embodiments or aspects of such embodiments may be shown in various figures and described throughout the specification. However, it should be noted that although shown or described separately each embodiment and aspects thereof may be combined with one or more of the other embodiments and aspects thereof unless expressly stated otherwise. It is merely for easing readability of the specification that each combination is not expressly set forth.

1. A simulated tissue structure comprising:
a frame having a top portion, a base and two sidewalls, wherein the frame has an opening at a proximal end of the frame;
a simulated vaginal canal that defines an internal space within the frame, the internal space having a first section near a proximal end of the simulated vaginal canal comprising a plurality of ridges, an opening at the proximal end of the simulated vaginal canal corresponding to the opening at the proximal end of the frame, and a second smooth section near the distal end of the simulated vaginal canal;
a simulated cervix located at and is connected to the distal end of the simulated vaginal canal such that a proximal end of the simulated cervix extends inside the simulated vaginal canal and a distal end of the simulated cervix extends past the internal space defined by the simulated vaginal canal; and
a support structure that is connected to the distal end of the simulated cervix, wherein the support structure is suspended within the frame via a plurality of cords, and wherein the plurality of cords are configured to allow the simulated cervix to move in response to user interaction.

2. The simulated tissue structure of claim 1 further comprising a grounding pad positioned on the top portion of the frame.

3. The simulated tissue structure of claim 1, wherein the support structure has an elongate tubular shape.

4. The simulated tissue structure of claim 1, wherein the frame further comprises a plurality of apertures, the apertures positioned on the two sidewalls and configured to receive one or more of the plurality of cords whereby the one or more of the plurality of cords are looped with the apertures to connect the one or more of the plurality of cords with the two sidewalls.

5. The simulated tissue structure of claim 1, wherein the plurality of cords comprise nylon.

6. The simulated tissue structure of claim 1, wherein the plurality of cords comprise yarn.

7. The simulated tissue structure of claim 1 further comprising a simulated vesicocervical space, the simulated vesicocervical space being positioned outside the distal end of the simulated vaginal canal and comprising at least two layers, wherein a first set of pre-determined locations are connected with an interface material which allows the two layers to be severable using blunt dissection, and wherein a second set of predetermined locations are molded together and are severable using sharp dissection.

8. The simulated tissue structure of claim 1, wherein the support structure is formed via yarn that is assembled onto a three-dimensional mandrel and cast within a mold.

9. The simulated tissue structure of claim 8, wherein the three-dimensional mandrel is formed from two or more separate two-dimensional components, and wherein the three-dimensional mandrel is a “plus-sign”.

10. The simulated tissue structure of claim 8, wherein a color of the yarn is different from the color of a material used to cast the support structure.

11. The simulated tissue structure of claim 1, wherein the support structure further comprises a reinforcement matrix or sleeve to further reinforce or provide tear resistance.

12. The simulated tissue structure of claim 1, wherein one or more of the simulated cervix, the support structure, the simulated vaginal canal, or the opening to the simulated vaginal canal comprises electroconductive material.

13. The simulated tissue structure of claim 3, wherein one or both of the frame or the plurality of cords comprises nonconductive material.

14. The simulated tissue structure of claim 7 further comprising a simulated bladder, wherein the simulated bladder is positioned above the simulated vesicocervical space, wherein the simulated bladder is connected to a filling tube and a pump, and wherein the simulated bladder is configured to expand via the pump.

15. The simulated tissue structure of claim 14, wherein the simulated bladder further comprises added batting at a top portion of the simulated bladder or a thickening of a material making up the top portion of the simulated bladder to provide a simulated resistance to the expansion of the simulated bladder in an upward direction when the simulated bladder is made to expand via the pump.

16. The simulated tissue structure of claim 7, wherein the simulated vaginal canal, the simulated cervix, the support structure, and the simulated vesicocervical space are formed as a monolithic piece or structure.

17. The simulated tissue structure of claim 1 further comprising a simulated peritoneum layer positioned at the distal end of the frame and attached to one or more of the support structure or the simulated cervix, wherein the simulated peritoneum layer is dissectable thereby allowing a user to access a simulated peritoneal cavity past the simulated peritoneum layer.

18. The simulated tissue structure of claim 17, wherein the simulated peritoneum layer comprises an electroconductive material.

19. The simulated tissue structure of claim 1, wherein the support structure further comprises a removable grounding cable adapted to be used during a simulated electrosurgical procedure.

20. The simulated tissue structure of claim 1, wherein the support structure further comprises a removable grounding pad.
